(19) United States
(12) Patent Application Publication
(10) Pub. No.: US 2009/0141420 A1
(43) Pub. Date: Jun. 4, 2009

(54) Packaged Capacitive Device And Methods Of Making The Same

(75) Inventors: Roy Joseph Bourcier, Corning, NY (US); Todd Michael Roswech, Ithaca, NY (US)

Correspondence Address: CORNING INCORPORATED, SP-TI-3-1, CORNING, NY, 14831, US

(73) Assignee: Corning Incorporated, Corning, NY (US)

(21) Appl. No.: 11/947,126

(22) Filed: Nov. 29, 2007

(51) Int. Cl. H01G 4/30; H01G 7/00

(52) U.S. Cl. 361/301.4; 29/25.42

(57) ABSTRACT

Packaged capacitive devices are described having electrical interconnects of electrodes which possess efficient electrical contact between current collectors, electrical isolation of electrodes, and/or electrochemical stability, while minimizing the mechanical stress and strain applied to the electrodes, in part, due to the use of a compliant layer. The packaged capacitive devices are adaptable to a wide range of electrode diameters and electrode stack lengths.

### BACKGROUND

1. Field of the Invention

The present invention relates generally to a packaged capacitive device and more particularly to a packaged capacitive device useful for capacitors and/or for capacitive deionization.

2. Technical Background

Capacitors, like batteries, store energy in the electrical field between a pair of oppositely charged conductive plates. Developed more than 250 years ago, capacitors are frequently used in electrical circuits as energy storage devices. In recent years, new families of capacitive devices have been developed which are based on charge separation of ions in solution and the formation of electrical double layers.

An electric double layer capacitor (EDLC) is an example of a capacitor that typically contains porous carbon electrodes (separated via a porous separator), current collectors and an electrolyte solution. When electric potential is applied to an EDLC cell, ionic current flows due to the attraction of anions to the positive electrode and cations to the negative electrode. Electric charge is stored in the electric double layer (EDL) formed along the interface between each polarized electrode and the electrolyte solution.

EDLC designs vary depending on application and can include, for example, standard jelly roll designs, prismatic designs, honeycomb designs, hybrid designs or other designs known in the art. The energy density and the specific power of an EDLC can be affected by the properties thereof, including the electrode and the electrolyte utilized. With respect to the electrode, high surface area carbons, carbon nanotubes, activated carbon and other forms of carbon and composites have been utilized in manufacturing such devices. Of these, carbon based electrodes are used in commercially available devices.

Capacitive Deionization (CDI) is a promising deionization technology, for instance, for the purification of water. In this context, positively and negatively charged electrodes are used to attract ions from a stream or bath of fluid. The ions form electric double layers on the surfaces of the electrodes, which are fabricated from some form of high surface area material, for example, a form of activated carbon. After interaction with the electrodes during the charging period, the fluid contains a lower overall ion content and is discharged. A volume of purge fluid is then introduced to the electrodes. The electrodes are then electrically discharged, thus releasing the trapped ions into the purge fluid. The purge fluid is then diverted into a waste stream and the process repeated.

Electrically connecting electrodes to a power source is a challenging aspect for EDLC and CDI applications. Typically, electrodes are delicate, thus mechanical stressing and straining of the electrodes should be minimized. Minimizing the deformations applied to the electrodes is difficult, especially while attempting to maximize the electrical and mechanical integrity of an electrical interconnect to the electrodes.

U.S. Pat. No. 5,954,937 relates to an interconnection for resorcinol/formaldehyde carbon aerogel/carbon paper sheet electrodes. The fluid flow path is located between the surfaces of the electrode sheets. The active surfaces of these electrode sheets are delicate and should be protected from mechanical stressing. The electrode sheets are bonded to a current collector, in this case, a titanium sheet using a conductive carbon filled adhesive. The large area of contact between the electrode sheet and the current collector insure relatively low overall resistance despite the moderately high resistivity of the adhesive interface.

U.S. Pat. No. 6,778,378 relates to electrodes which may be rolled from carbon and fibrillated polytetrafluoroethylene (PTFE). Electrodes formed in this fashion are thin flexible sheets which can be contacted by high normal compressive forces. Electrodes may be stacked up with sheets of current collector material and a separator material and then clamped with a compressive force to obtain good electrical contact. By controlling which electrodes and current collectors are in physical contact, a capacitive cell may be formed.

A flow-through (rather than parallel plate) flow geometry is described in commonly owned U.S. Pat. No. 6,214,204. In this reference, monolithic, low back pressure porous electrodes are made by one of several methods, which include honeycomb extrusion, casting or molding from a phenolic resin-based batch. After curing, these parts are carbonized and activated to create high surface area carbon monoliths with good electrical conductivity.

Discs are made and assembled in a stack and spaced such that the discs are electrically isolated from each other. The discs are connected to anode and cathode current collector/bus bar assemblies utilizing wires.

A variety of other approaches of electrically interconnecting electrodes and packaging the electrodes to form packaged devices have been considered in the art with one or more disadvantages as described below. Brazing or soldering alloys typically will not withstand either the EDLC or the CDI electrochemical environments. Brazing and/or soldering to carbon is difficult due, in part, to the low strength of activated carbon. Conductive adhesives formulated using highly conductive metal powders are costly and/or are prone to corrosion. Conductive adhesives formulated using carbon powders generally have insufficient electrical conductivity for use in a capacitor.

Conductive wire or strip leads mechanically fastened around the perimeter of a capacitive device provide adequate performance for small electrodes. However the resistive losses introduced by conducting charge around the circumference of the electrode in a small diameter wire or thin strip lead degrade performance, and no simple means has been found to use this attachment scheme while incorporating a high efficiency current collector. Also, the logistics of attaching leads to individual electrodes are not appealing.

Further, packaging the resulting interconnected electrodes is challenging due, in part, to the typical packaging materials being rigid materials which can compromise the mechanical integrity of the electrodes.

It would be advantageous to develop a packaged capacitive device comprising interconnected electrodes which are capable of non-impeded fluid flow through the electrodes, which is useful for, for example, CDI. Further, it would be advantageous to have a packaged capacitive device wherein the packaging enhances the electrical interconnect to a linear stack of monolithic high surface area carbon electrodes and does not jeopardize the mechanical integrity of the electrodes. Also, it would be advantageous to have the methods of packaging a capacitive device provide a reduction in processing steps and a cost reduction in the manufacturing process.

### SUMMARY

One embodiment of the invention is a packaged capacitive device comprising a linear stack comprising two or more electrodes arranged in series. At least two current collectors are each in electrical contact with one or more electrodes in the linear stack. The electrodes in electrical contact with one current collector are insulated from electrical contact with another current collector. A compliant layer encloses the linear stack and current collectors. The compliant layer is under circumferential tensile stress and applies radial compressive stress to the linear stack and current collectors to ensure electrical contact between the current collectors and respective electrodes in the linear stack.

Another embodiment of the invention is a method of making a packaged capacitive device. The method comprises providing a linear stack comprising two or more electrodes arranged in series, providing at least two current collectors, each in contact with one or more electrodes in the linear stack, wherein electrodes in contact with one current collector are insulated from contact with another current collector, and applying a compliant layer enclosing the linear stack, and the current collectors.

The packaged capacitive device according to the invention provides one or more of the following advantages: efficient electrical contact, good electrical isolation, and good electrochemical stability, while requiring a very modest level of stress be applied to the electrodes. The packaging for the capacitive device is readily adaptable to a wide range of electrode diameters and linear stack lengths.

Additional features and advantages of the invention will be set forth in the detailed description which follows, and in part will be readily apparent to those skilled in the art from the description or recognized by practicing the invention as described in the written description and claims hereof, as well as the appended drawings.

It is to be understood that both the foregoing general description and the following detailed description are merely exemplary of the invention, and are intended to provide an overview or framework for understanding the nature and character of the invention as it is claimed.

The accompanying drawings are included to provide a further understanding of the invention, and are incorporated in and constitute a part of this specification. The drawings illustrate one or more embodiment(s) of the invention and together with the description serve to explain the principles and operation of the invention.

### BRIEF DESCRIPTION OF THE DRAWINGS

The invention can be understood from the following detailed description either alone or together with the accompanying drawing figures.

FIG. 1 is an exploded view schematic of a packaged capacitive device according to one embodiment of the invention.

FIG. 2a is a cross-sectional schematic of a packaged device according to one embodiment of the invention.

FIG. 2b is a cross-sectional schematic of a packaged device according to one embodiment of the invention.

FIG. 3 is a photograph of a packaged device according to one embodiment of the invention.

FIG. 4 is a photograph of a packaged device according to one embodiment of the invention.

### DETAILED DESCRIPTION

Reference will now be made in detail to various embodiments of the invention, examples of which are illustrated in the accompanying drawings. Wherever possible, the same reference numbers will be used throughout the drawings to refer to the same or like parts.

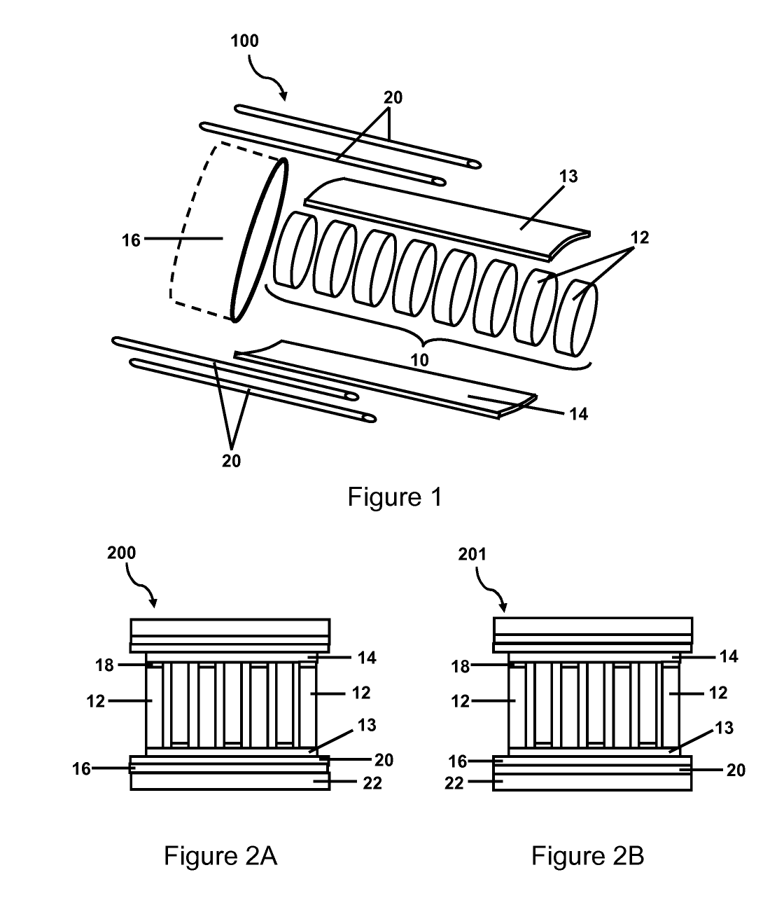

One embodiment of the invention, as shown by the exploded view schematic in FIG. 1, is a packaged capacitive device 100 comprising a linear stack 10 comprising two or more electrodes 12 arranged in series. At least two current collectors 13 and 14 are each in electrical contact with one or more electrodes in the linear stack. The electrodes in electrical contact with one current collector are insulated from electrical contact with another current collector as shown by feature 18 in FIG. 2a and FIG. 2b. A compliant layer 16 encloses the linear stack and current collectors. The compliant layer is under circumferential tensile stress and applies radial compressive stress to the linear stack and current collectors to ensure electrical contact between the current collectors and respective electrodes in the linear stack.

According to one embodiment, the compliant layer is selected from a heat shrink thermoplastic polymer, an elastomer and combinations thereof. When the compliant layer is a heat shrink thermoplastic polymer, according to some embodiments, the heat shrink thermoplastic polymer is selected from a polyolefin, a fluoropolymer, a Poly(vinyl chloride) (PVC), a neoprene, a silicone, a fluoroelastomer, for example, Viton®, available from Dupont and combinations thereof. According to some embodiments, when the compliant layer is an elastomer, the elastomer is selected from a saturated rubber, an unsaturated rubber, a thermoplastic, a thermoplastic vulcanizate, a polyurethane rubber, a polysulfide rubber and a combination thereof. According to one embodiment, the compliant layer is in a form selected from a sleeve, a tube, a wrapped sheet and a combination thereof.

In a packaged capacitive device, according to one embodiment, the linear stack is cylindrical and each electrode has a circular perimeter. According to other embodiments, the electrodes and subsequently, the linear stack can be, for example, polygonal, circular, cylindrical, square, cubed, triangular, pentagonal, hexagonal or a combination thereof.

Each electrode in the linear stack, in one embodiment, is a flow-through electrode. Each electrode can comprise a plurality of inner channels having surfaces defined by porous walls and extending through the electrode from a first face to an opposing second face, for example, each electrode can be in the form of a honeycomb monolith. According to one embodiment, the electrode material for each electrode is selected from a carbon, a carbon-based composite, a carbon-based laminate, a conductive metal oxide, a conductive polymer and combinations thereof.

According to one embodiment, the current collectors are, independently, a material selected from nickel, carbon, graphite, titanium, aluminum, nickel, copper, silver, gold, platinum and combinations thereof. The current collectors can be in the form of a compliant sheet.

As shown by the cross-sectional schematics in FIG. 2a and FIG. 2b, the packaged capacitive device 200 and 201 respectively, according to some embodiments, further comprises a rigid outer housing 22 enclosing the linear stack comprising two or more electrodes 12, the current collectors 13 and 14, and the compliant layer 16. The rigid outer housing can provide additional mechanical protection and may also provide additional mechanical pressure to enhance the electrical contact within the capacitive device.

According to some embodiments, as shown in FIG. 1, FIG. 2a and/or FIG. 2b, the packaged capacitive device further comprises at least one reinforcing rib 20 disposed between the linear stack comprising two or more electrodes 12 and the rigid outer housing 22. The packaged capacitive device, in some embodiments, comprises two or more reinforcing ribs axially disposed to the compliant layer. In one embodiment, as shown in FIG. 2a, the reinforcing ribs 20 are disposed between the linear stack comprising two or more electrodes 12 and the compliant layer 16. In one embodiment, as shown in FIG. 2b, the reinforcing ribs 20 are disposed between the compliant layer 16 and the rigid outer housing 22. According to another embodiment, the current collectors, when rigid, function as current collectors and as reinforcing ribs. A reinforcing rib internal or external to the shrink tube can enhance the mechanical robustness of the packaged capacitive device.

The reinforcing rib material, in some embodiments, is selected from a structural polymer, a metal, a ceramic, and a combination thereof. The packaged capacitive device, in some embodiments, comprises two or more reinforcing ribs axially disposed to the compliant layer.

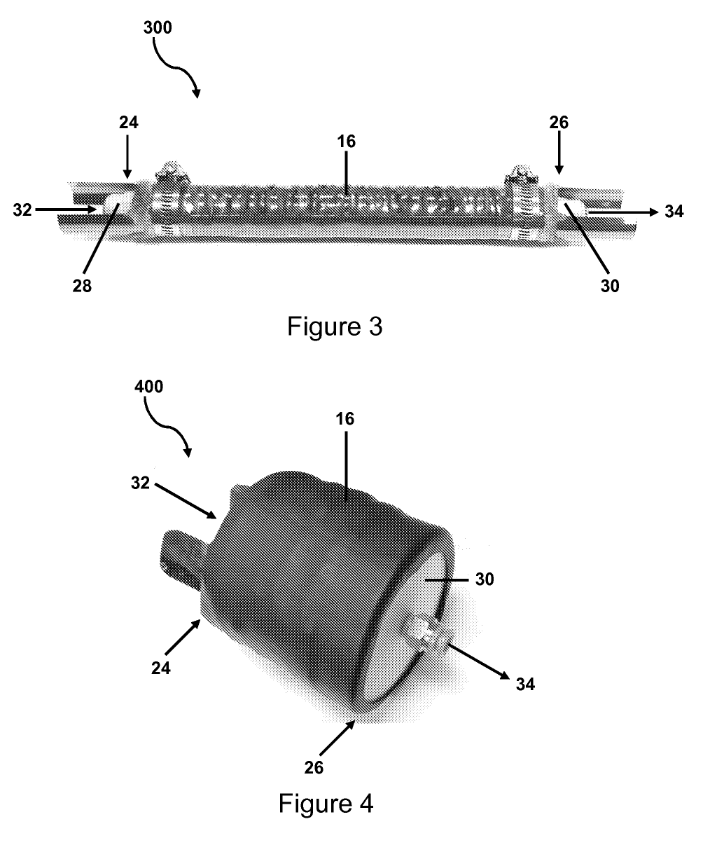

According to some embodiments, as shown in the photographs in FIG. 3 and FIG. 4, the packaged capacitive device 300 and 400 respectively, further comprises a first fluidic plug 28 (not shown in FIG. 4) adjacent to a first end 24 of the linear stack and a second fluidic plug 30 adjacent to a second end 26 of the linear stack. In one embodiment, the first fluidic plug comprises an inlet 32 for receiving a fluid and the second fluidic plug comprises an outlet 34 for discharging at least a portion of the fluid received by the inlet. In one embodiment, the inlet and/or the outlet comprises a valve for regulating the flow of a fluid. The first fluidic plug and the second fluidic plug can be sealed to the linear stack by the compliant layer. The inlet and/or the outlet, in some embodiments, are connectorized to allow attachment to a flow system.

Another embodiment of the invention is a method of making a packaged capacitive device. The method comprises providing a linear stack comprising two or more electrodes arranged in series, providing at least two current collectors, each in contact with one or more electrodes in the linear stack, wherein electrodes in contact with one current collector are insulated from contact with another current collector, and applying a compliant layer enclosing the linear stack, and the current collectors. The two or more electrodes are electrically isolated from adjacent electrodes in the linear stack, such that in an anode and cathode array, adjacent electrodes do not short together. In one embodiment, adjacent electrodes are isolated via a physical space. In another embodiment, an electrically insulating material is disposed between adjacent electrodes.

In one embodiment, applying the compliant layer comprises diametrically expanding an elastomeric housing, positioning it around the linear stack and the current collectors, and removing the expanding forces and allowing the compliant layer to contract to apply radial and axial compressive forces to the linear stack and current collectors. In some embodiments, allowing the compliant layer to contract to apply radial and axial compressive forces to the linear stack and current collectors comprises applying heat to the compliant layer such that the compliant layer shrinks and conforms to the shape of the linear stack and the current collectors.

The method of making a packaged capacitive device can further comprise attaching a first fluidic plug adjacent to a first end of the linear stack and a second fluidic plug adjacent to a second end of the linear stack. In one embodiment, the first fluidic plug comprises an inlet for receiving a fluid and the second fluidic plug comprises an outlet for discharging at least a portion of the fluid received by the inlet. In one embodiment, the inlet and/or the outlet comprises a valve for regulating the flow of a fluid.

According the methods described herein, a water-tight packaged capacitive device may be achieved through the judicious use of mechanical pressure, sealant, or careful material selection. Robust mechanical and electrical contact between the electrodes and their like-signed current collector can be achieved, while providing isolation from an opposite-signed current collector.

### EXAMPLE I

The packaged capacitive device shown in FIG. 3 comprises a linear stack of 50 activated carbon electrodes, which are 25 mm in diameter×3 mm in thickness. The electrodes were processed from a phenolic resin-based extruded honeycomb cylinder, for example, similar to those described in U.S. Pat. No. 6,214,204.

The electrodes in electrical contact with one current collector were insulated from electrical contact with another current collector using an electrically insulating compliant material. In this embodiment, insulators and spacers made from Dow Corning Sylgard 184 were applied to each electrode, covering approximately 180 degrees of the circumference of each electrode. Each sequential electrode was rotated 180 degrees about its cylindrical axis so that the silicone strips on adjacent electrodes were diametrically opposed. These molded pieces provide isolation for each electrode from the oppositely signed current collector and isolation from the adjacent electrodes.

Fluidic plugs having a cylindrical shape were made from a machinable engineering plastic and are 25 mm in diameter×mm in thickness. The fluidic plugs were placed on each end of the linear stack. Both fluidic plugs contain a drilled and tapped through hole containing a ¼″ quick connect tubing connector. Two strips of rolled exfoliated graphite sheet, for example, Grafoil®, available from Graftech Inc. 175 mm×mm×0.05 mm were placed adjacent to the linear stack and diametrically opposed with respect to each other. These strips act as current collectors. Two strips of commercially pure titanium foil 30 mm×75 mm×0.25 mm were placed at each end of the capacitive device, overlapping the Grafoil® sheets. These form the electrical interface to the environment in the packaged capacitive device. Then a 180 mm in length piece of 30 mm in diameter FEP shrink tube was placed over the linear stack, the current collectors, the titanium sheets, and the fluidic plugs. The shrink tube was shrunk to conform to the linear stack, the current collectors, the titanium sheets, and the fluidic plugs using a heat gun with a nozzle air temperature of approximately 300° C. Heating continued until the tubing drew down tightly, bringing the Grafoil® current collectors into mechanical contact with the electrodes.

A stainless steel hose clamp was placed around each end of the capacitive device and tightened. The hose clamps serve to achieve good electrical contact between the titanium and the graphite sheet and to help minimize fluidic leakage. 732 RTV sealant, commercially available from Dow Corning, was applied to both ends of the device to further seal against leakage.

### EXAMPLE II

One embodiment of a packaged capacitive device according to the invention is shown in FIG. 4. The capacitive device 400 comprises a linear stack of 6 activated carbon electrodes arranged in series. The carbon electrodes are 75 mm in diameter by 3 mm in thickness. The electrodes were processed from a phenolic resin-based extruded honeycomb cylinder, for example, similar to those described in U.S. Pat. No. 6,214,204. Strips of 3 mm thick silicone sheet were placed on the electrodes, covering approximately 180 degrees of the circumference of each electrode, and were bonded to the electrodes using 732 RTV sealant. Each sequential electrode was rotated 180 degrees about its cylindrical axis so that the silicone strips on adjacent electrodes were diametrically opposed. Rings of 1 mm thick silicone sheet were placed between adjacent electrodes to electrically isolate them from each other. A first fluidic plug, in this embodiment, a disc of machinable engineering plastic 75 mm in diameter×25 mm in thickness were placed on each end of the linear stack. Both fluidic plugs contained a drilled and tapped through hole containing a ¼ inch quick connect tubing connector. Two strips of Nickel foil 120 mm×30 mm×0.09 mm were placed adjacent to the electrode stack diametrically opposed with respect to each other. Then a 120 mm long piece of 100 mm in diameter of FEP shrink tube was placed over this stack of components and shrunk to conform using a heat gun having a nozzle air temperature of approximately 300° C. Heating continued until the tubing drew down tightly onto the stack, bringing the Nickel foil current collectors into mechanical contact with the electrodes.

It will be apparent to those skilled in the art that various modifications and variations can be made to the present invention without departing from the spirit or scope of the invention. Thus, it is intended that the present invention cover the modifications and variations of this invention provided they come within the scope of the appended claims and their equivalents.

What is claimed is:

1. A packaged capacitive device comprising
a linear stack comprising two or more electrodes arranged in series;
at least two current collectors, each in electrical contact with one or more electrodes in the linear stack, wherein electrodes in electrical contact with one current collector are insulated from electrical contact with another current collector; and
a compliant layer enclosing the linear stack and current collectors, wherein the compliant layer is under circumferential tensile stress and applies radial compressive stress to the linear stack and current collectors to ensure electrical contact between the current collectors and respective electrodes in the linear stack.

2. The packaged capacitive device according to claim 1, wherein the compliant layer is selected from a heat shrink thermoplastic polymer, an elastomer and combinations thereof.

3. The packaged capacitive device according to claim 2, wherein the heat shrink thermoplastic polymer is selected from a polyolefin, a fluoropolymer, a poly (vinyl chloride), a neoprene, a silicone, a fluoroelastomer and combinations thereof.

4. The packaged capacitive device according to claim 2, wherein the elastomer is selected from a saturated rubber, an unsaturated rubber, a thermoplastic, a thermoplastic vulcanizate, a polyurethane rubber, a polysulfide rubber and a combination thereof

5. The packaged capacitive device according to claim 1, wherein the compliant layer is in a form selected from a sleeve, a tube, a wrapped sheet and a combination thereof.

6. The packaged capacitive device according to claim 1, further comprising a first fluidic plug adjacent to a first end of the linear stack and a second fluidic plug adjacent to a second end of the linear stack.

7. The packaged capacitive device according to claim 6, wherein the first fluidic plug comprises an inlet for receiving a fluid and the second fluidic plug comprises an outlet for discharging at least a portion of the fluid received by the inlet.

8. The packaged capacitive device according to claim 6, wherein the first fluidic plug and the second fluidic plug are sealed to the linear stack by the compliant layer.

9. The packaged capacitive device according to claim 1, wherein the linear stack is cylindrical.

10. The packaged capacitive device according to claim 1, wherein each electrode in the linear stack is a flow-through electrode.

11. The packaged capacitive device according to claim 10, wherein each electrode comprises a plurality of inner channels having surfaces defined by porous walls and extending through the electrode from a first face to an opposing second face.

12. The packaged capacitive device according to claim 10, wherein the electrode material for each electrode is selected from a carbon, a carbon-based composite, a carbon-based laminate, a conductive metal oxide, a conductive polymer and combinations thereof.

13. The packaged capacitive device according to claim 1, wherein the current collectors are, independently, a material selected from nickel, carbon, graphite, titanium, aluminum, nickel, copper, silver, gold, platinum and combinations thereof.

14. The packaged capacitive device according to claim 13, wherein the current collectors are in the form of a compliant sheet.

15. The packaged capacitive device according to claim 1, further comprising a rigid outer housing enclosing the linear stack, the current collectors, and the compliant layer.

16. The packaged capacitive device according to claim 15, further comprising at least one reinforcing rib disposed between the linear stack and the rigid outer housing.

17. The packaged capacitive device according to claim 16, wherein the reinforcing rib material is selected from a structural polymer, a metal, a ceramic, and a combination thereof.

18. The packaged capacitive device according to claim 16, comprising two or more reinforcing ribs axially disposed to the compliant layer.

19. A method of making a packaged capacitive device, the method comprising:
providing a linear stack comprising two or more electrodes arranged in series;
providing at least two current collectors, each in contact with one or more electrodes in the linear stack, wherein electrodes in contact with one current collector are insulated from contact with another current collector; and
applying a compliant layer enclosing the linear stack, and the current collectors.

20. The method according to claim 19, wherein applying the compliant layer comprises diametrically expanding an elastomeric housing, positioning it around the linear stack and the current collectors, and removing the expanding forces and allowing the compliant layer to contract to apply radial and axial compressive forces to the linear stack and current collectors.

21. The method according to claim 20, wherein allowing the compliant layer to contract to apply radial and axial compressive forces to the linear stack and current collectors comprises applying heat to the compliant layer such that the compliant layer shrinks and conforms to the shape of the linear stack and the current collectors.

22. The method according to claim 19, further comprising attaching a first fluidic plug adjacent to a first end of the linear stack and a second fluidic plug adjacent to a second end of the linear stack.

23. The method according to claim 22, wherein the first fluidic plug comprises an inlet for receiving a fluid and the second fluidic plug comprises an outlet for discharging at least a portion of the fluid received by the inlet.
